(19) United States
(12) Patent Application Publication
(10) Pub. No.: US 2021/0296777 A1
(43) Pub. Date: Sep. 23, 2021

(54) Radiating Coaxial Cable

(71) Applicant: Prysmian S.p.A., Milano (IT)

(72) Inventor: Mika Manninen, Oulu (FI)

(21) Appl. No.: 17/205,164

(22) Filed: Mar. 18, 2021

(30) Foreign Application Priority Data
Mar. 20, 2020 (IT) 102020000005983

(51) Int. Cl. H01Q 13/20; H01B 11/18; H01Q 1/00

(52) U.S. Cl. CPC H01Q 13/203; H01Q 1/007; H01B 11/1808

(57) ABSTRACT

Disclosed is a radiating coaxial cable wherein at least one geometric property of the radiating apertures of the cable conductive shield is varied longitudinally, so as to longitudinally vary the shape of the radiation pattern of the cable in a predefined way. Such radiating coaxial cable allows providing a non-uniform radiofrequency coverage by installing a single cable. For example, in a building with different areas having different coverage requirements, the geometric properties of the radiating apertures of the cable may be varied so as to longitudinally vary the shape of the radiation pattern to meet the coverage requirements of the various areas crossed by the cable.

### CROSS-REFERENCE TO RELATED APPLICATIONS

This application claims the benefit of Italian Patent Application No. 102020000005983 filed on Mar. 20, 2020, which application is hereby incorporated herein by reference.

### TECHNICAL FIELD

The present disclosure relates to the field of coaxial cables. In particular, the present disclosure relates to radiating coaxial cables and to processes for manufacturing a radiating coaxial cable.

### BACKGROUND

As known, a radiating coaxial cable (also known as “leaky coaxial cable”) is a coaxial cable configured to emit and receive radio waves at a specific radiofrequency or in a specific radiofrequency range, so as to function as an extended antenna. Radiating coaxial cables are typically used to provide uniform radiofrequency coverage (for example, mobile coverage) to extended and/or narrow indoor environments, such as tunnels (metro, railway and road tunnels), buildings (e.g. office corridors, shopping centers or parking garages), mines or ships.

Known coaxial cables comprise an inner conductor surrounded by an insulating layer, a tubular conductive shield (a.k.a. “outer conductor”) and a jacket, which is typically the outermost cable layer. In radiating coaxial cables, a plurality of apertures (like slots or holes) is punched/milled through in the shield to allow the radio waves to leak into and out of the cable along its length.

The power radiated by a radiating coaxial cable has an angular dependence, namely a radiation pattern. The radiation pattern may be represented graphically as a plot of the radiated power as received by a test receiver, placed at a predefined distance from the cable (e.g. 4 meters), as a function of the receiver angular position. The radiation pattern typically shows one or more radiated power maxima called “lobes” separated by “nulls” at which the radiated power is substantially lower, even zero.

The shape of the radiation pattern (in particular, the number of lobes and their angular position) depends on the arrangement of the radiating apertures in the cable shield. For example, a single straight line of radiating apertures may be provided in the cable shield, so that the coaxial cable (a.k.a. “RFX cable”) has a single radiating side. In this case, the radiation pattern exhibits a single, large lobe centered at the angular position of the radiating apertures. As another example, two diametrically opposed straight lines of radiating apertures may be provided in the cable shield, so that the coaxial cable (a.k.a. “RF2X” cable”) has two opposite radiating sides. In this case, the radiation pattern exhibits two substantially diametrically opposed lobes.

U.S. Pat. No. 5,276,413 describes a radiating cable whose shield has a number of openings increasing along the cable. The increase in the number of openings along the cable nearly balances any decrease in the radiated power caused by attenuation of the cable. The radiated power then remains approximately constant along the cable.

### SUMMARY

In one embodiment a radiating coaxial cable comprises an inner conductor, an insulating layer surrounding and directly contacting the inner conductor, a continuous conductive shield surrounding said insulating layer and comprising a plurality of radiating apertures, and a jacket surrounding the conductive shield. At least one geometric property of the radiating apertures varies along a longitudinal direction of the cable and the cable has a radiation pattern with a shape longitudinally varying in a predefined way.

In one embodiment, a process for manufacturing a radiating coaxial cable includes surrounding an inner conductor with an insulating layer, the insulating layer directly contacting the inner conductor, providing a continuous conductive shield in the form of an electrically conductive metal foil comprising, from end to end, a plurality of radiating apertures, the metal foil longitudinally wrapping the insulating layer, and surrounding the conductive shield with a jacket. At least one geometric property of the plurality of radiating apertures varyies along the longitudinal direction of the cable and the cable having a radiation pattern with a shape longitudinally varying in a predefined way.

In one embodiment, a method for providing a varying radiofrequency coverage includes transmitting a radiofrequency signal by using a single radiating coaxial cable that comprises an inner conductor, an insulating layer, a continuous conductive shield, and a jacket. The insulating layer surrounds and directly contacts the inner conductor, the continuous conductive shield surrounds the insulating layer and comprises a plurality of radiating apertures, and the jacket surrounds the conductive shield. At least one geometric property of the plurality of radiating apertures varies along a longitudinal direction of the cable and the cable has, from end to end, a radiation pattern with a shape longitudinally varying in a predefined way.

### BRIEF DESCRIPTION OF THE DRAWINGS

The present disclosure will become fully clear after reading the following detailed description, given by way of example and not of limitation, with reference to the attached drawings wherein:

FIG. 1 schematically shows a lateral view of portion of a radiating coaxial cable according to an embodiment of the present disclosure;

FIGS. 2(a)-(g) show exemplary arrangements of the radiating apertures in the cable in FIG. 1;

FIG. 3 shows an exemplary non-monotonic variation of a geometrical property of the radiating apertures in the cable in FIG. 1;

FIG. 4 is graph showing the longitudinal profile of the radiated power resulting from the non-monotonic variation of FIG. 3; and

FIG. 5 is an exemplary scenario where the radiating coaxial cable according to embodiments of the present disclosure may be used.

### DETAILED DESCRIPTION OF ILLUSTRATIVE EMBODIMENTS

The Applicant has noticed that, while the cable of U.S. Pat. No. 5,276,413 aims at providing a radiofrequency coverage as uniform as possible, in some contexts a non-uniform radiofrequency coverage could be instead desirable.

For example, within a building (e.g. with offices and/or manufacturing facilities), the rooms to be covered may vary in size and arrangement. For examples, in some areas of the building all the rooms may be arranged on a single side of a corridor, while in other areas of the building (or even other parts of the same corridor) the rooms could be arranged on both sides. Large rooms such as auditorium, canteen or meeting rooms require a wider coverage. Besides, other areas of the building could require no coverage at all, e.g. areas that shall be radiation-free for safety reasons (for instance some rooms in a hospital) or passages where no coverage is needed. Some areas could be covered by a reduced field strength.

In principle, a non-uniform radiofrequency coverage could be provided by installing in the various building areas (e.g. along the corridors of the building) lengths of radiating coaxial cables of different types, such as RFX and RF2X. For instance, a length of RFX cable could be installed where the rooms to be covered are arranged on a single side of the corridor, a length of RF2X cable could be installed where the rooms are arranged on both sides of the corridor, while a length of RFX cable with higher radiated power (for example, with larger radiating apertures) could be installed where larger rooms such as auditorium or canteen are located. The various lengths of cables of different types should be reciprocally joined, so as to form a single coverage system which may be fed by a radiofrequency source at one its ends.

The Applicant has noticed that using lengths of radiating coaxial cables of different types makes the installation procedure complex and costly. Joining the various cable lengths of different types is a complex and long operation, which moreover induces additional loss (namely, the insertion loss of the cable joints) in the overall coverage system. Some cable types moreover are not mutually compatible, so they cannot be joined. In this case, they must be fed separately by respective radio frequency sources, thereby further increasing the cost of the coverage system.

The Applicant has then faced the difficulty of providing a radiating coaxial cable which allows reducing duration, complexity and cost of installation in contexts wherein a non-uniform radiofrequency coverage is required, such as for example a building wherein rooms to be covered vary in size and arrangement.

According to embodiments of the present disclosure, a radiating coaxial cable comprises a conductive shield that comprises, from end to end, a plurality of radiating apertures, wherein at least one geometric property of the radiating apertures is varied along the longitudinal direction of the cable so as to longitudinally vary the shape of the radiation pattern of the cable in a predefined way.

The expression “geometric property of the radiating apertures” comprises either a geometric property of the single radiating aperture, in particular shape, size, orientation or angular position, or a geometric property collectively describing the arrangement of radiating apertures in a set on the cable shield, in particular their reciprocal radial and/or longitudinal position, the number of lines according to which they are arranged and the shape of such line(s) (straight, wavy, helical and so on).

By “varying the shape of the radiation pattern of the cable” it is meant varying the number of lobes and/or the angular position(s) of the lobe(s) and/or the angular width of the lobe(s) and/or the amplitude of the lobe(s).

The radiating coaxial cable according to embodiments of the present disclosure allows providing a non-uniform radiofrequency coverage by installing a single cable. In the above exemplary scenario of a building with different areas having different coverage requirements, the geometric properties of the radiating apertures may be varied along the cable, so as to longitudinally vary the shape of the radiation pattern to meet the coverage requirements of the various areas crossed by the cable.

For example, in a first section of the cable shield the radiating apertures may be arranged in a single longitudinal straight line, resulting in a radiation pattern with a single lobe providing radiofrequency coverage in an area with e.g. rooms arranged on a single side of the corridor; the first section may be followed by a second section where the radiating apertures are arranged in two diametrically opposed longitudinal straight lines, resulting in a radiation pattern with two lobes providing radiofrequency coverage in an area with e.g. rooms arranged on both sides of the corridor; and so on.

Use of a single cable makes the installation procedure quicker and simpler, thereby allowing saving installation costs. Moreover, since no joints between different lengths of cable are required, the loss of the overall line is decreased.

Therefore, according to a first aspect, the present disclosure provides for a radiating coaxial cable comprising: an inner conductor; an insulating layer surrounding and directly contacting the inner conductor; a continuous conductive shield surrounding the insulating layer and comprising a plurality of radiating apertures; and a jacket surrounding the conductive shield, wherein at least one geometric property of the plurality of radiating apertures comprised in the continuous conductive shield varies along the longitudinal direction of the cable and the cable has a radiation pattern with a shape longitudinally varying in a predefined way.

According to an embodiment, the cable comprises at least two contiguous sections having different arrangements of the radiating apertures and radiation patterns with different shapes.

According to an embodiment, the arrangement of the radiating apertures in each one of the at least two contiguous sections comprises a single alignment, a double alignment or a multiple alignment of radiating apertures.

The transition between the arrangements of radiating apertures in two contiguous sections may be single-step or gradual.

According to an embodiment, the cable comprises at least one section wherein the at least one geometric property of the radiating apertures is varied in a non-monotonic way.

According to an embodiment, the cable also comprises at least one section with no radiating apertures.

According to a second aspect, the present disclosure relates to a process for manufacturing a radiating coaxial cable, said process comprising: providing an inner conductor; providing an insulating layer surrounding and directly contacting the inner conductor; providing a continuous conductive shield in form of an electrically conductive metal foil comprising, from end to end, a plurality of radiating apertures, the metal foil longitudinally wrapping the insulating layer; and providing a jacket surrounding the conductive shield, wherein at least one geometric property of the plurality of radiating apertures comprised in the continuous conductive shield is varied along the longitudinal direction of the cable and the cable has a radiation pattern with a shape longitudinally varying in a predefined way.

According to a third aspect, the present disclosure relates to a method for providing a varying radiofrequency coverage comprising transmitting a radiofrequency signal by using a single radiating coaxial cable comprising: an inner conductor; an insulating layer surrounding and directly contacting the inner conductor; a continuous conductive shield surrounding the insulating layer and comprising a plurality of radiating apertures; and a jacket surrounding the conductive shield, wherein at least one geometric property of the plurality of radiating apertures comprised in the continuous conductive shield varies along the longitudinal direction of the cable and the cable has a radiation pattern with a shape longitudinally varying in a predefined way.

The frequency of the radiofrequency signal transmitted by the cable of the present disclosure can vary from 20 kHz to 10 GHz, for example from 5 MHz to 4 GHz.

For the purpose of the present description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

The present disclosure, in at least one of the aforementioned aspects, can be implemented according to one or more of the following embodiments, optionally combined together.

For the purpose of the present description and of the appended claims, the words “a” or “an” should be read to include one or at least one and the singular also includes the plural unless it is obvious that it is meant otherwise. This is done merely for convenience and to give a general sense of the disclosure.

The reference numbers used in all the Figures shall be the same for equivalent cables and cable portions.

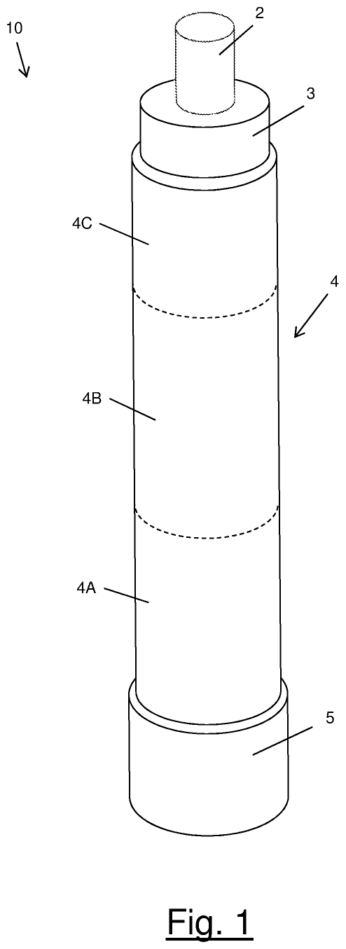

FIG. 1 shows a lateral view of a portion of a radiating coaxial cable 10 according to an embodiment of the present disclosure.

The cable 10 comprises an inner conductor 2 surrounded by an insulating layer 3, a tubular conductive shield 4 and a jacket 5. The jacket 5 may be the outermost layer of the cable 10. The cable 10 may also comprise other layers (e.g. a fire barrier or wrapping tape interposed between conductive shield 4 and jacket 5 and/or interposed between insulating layer 3 and conductive shield 4), which are not shown in the Figures and will not be described herein below.

The inner conductor 2 may be single core or multicore, hollow or solid. In case of hollow conductor/s, it/they can be in form of a corrugated welded tube. The inner conductor 2 is made of an electrically conductive metal such as copper, aluminum or composite thereof. The inner conductor 2 can have an outer diameter comprised between 1 mm and 25 mm.

The insulating layer 3 can be made of polyethylene, optionally foamed, or other suitable electrically insulating material. The insulating layer 3 can have an outer diameter comprised between 5 mm and 55 mm and a thickness comprised between 1 mm and 20 mm.

The tubular conductive shield 4 is made of an electrically conductive metal such as copper, aluminum or composite thereof. The shield 4 may be either a smooth or corrugated metal layer. The shield metal layer may be in form of a metal foil longitudinally wrapped around the insulating layer 3 and either welded or with glued lapping rims. The conductive shield 4 can have an outer diameter comprised between 5 mm and 60 mm and a thickness comprised between 0.03 mm and 4 mm (including corrugations, if present).

The jacket 5 is made of a polymeric material, such as polyethylene. Optionally, the jacket 5 may have flame retardant properties. For example, the jacket 5 may be made of a halogen free flame retardant polymeric material, either thermoplastic or crosslinked.

The conductive shield 4 is provided with a plurality of radiating apertures (not shown in FIG. 1) allowing the radio waves to leak into and out of the cable 10, which accordingly acts as an antenna.

The conductive shield 4 may be obtained by a single smooth metal foil, which is longitudinally wrapped (and optionally overlapped) about the insulating layer 3. The radiating apertures may be punched (or milled) through the smooth metal foil before it is wrapped about the insulating layer 3.

In an embodiment, at least one geometric property of the radiating apertures is varied along the longitudinal direction of the cable 10, so as to longitudinally vary the shape of the radiation pattern of the cable 10 in a predefined way. In particular, one or more of the following geometric properties may be varied: a geometric property of the single radiating aperture, including its shape, size, orientation or angular position; and/or a geometric property collectively describing the arrangement in a set of radiating apertures on the conductive shield 4, in particular their reciprocal radial and/or longitudinal position, the number of alignments according to which they are arranged and the shape of such alignment(s) (straight, wavy, helical and so on).

As it will be described in detail herein below, indeed, such geometrical properties of the radiating apertures determine the shape of the radiation pattern of the cable 10.

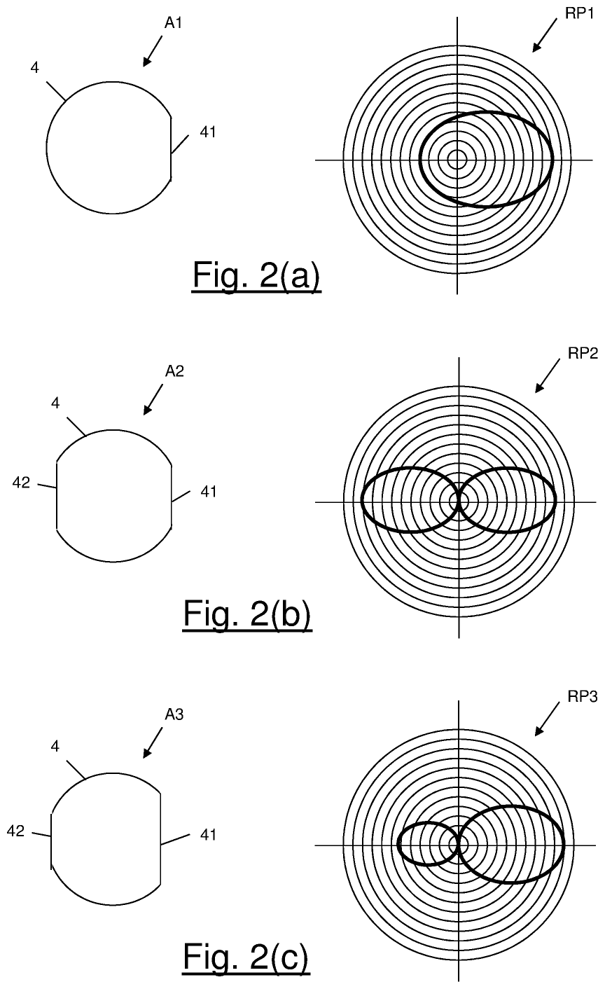

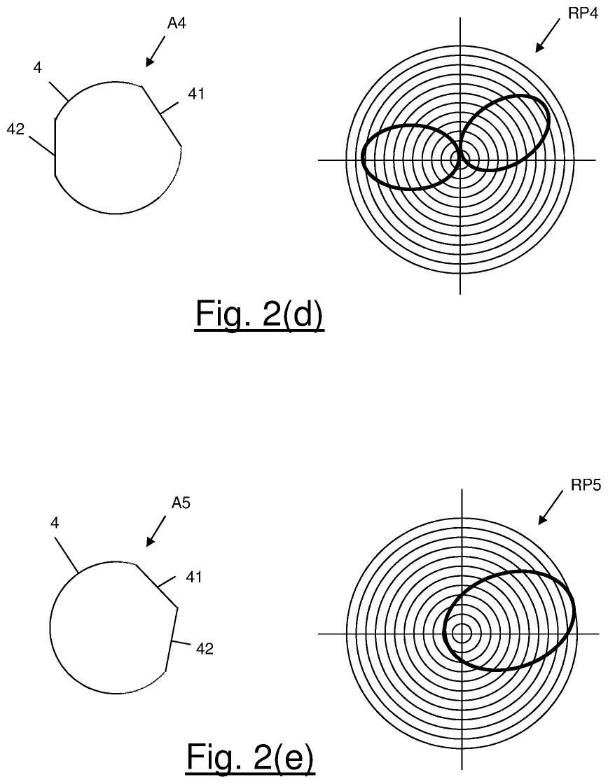

FIGS. 2(a)-(g) show exemplary arrangements of the radiating apertures in a cable according to the present disclosure and, for each shown arrangement, the resulting radiation pattern. The radiation patterns depicted in FIGS. 2(a)-(g) are qualitative and schematic.

As depicted in FIG. 2(a), an arrangement A1 wherein a plurality of radiating apertures is arranged in a single straight line 41 provides a radiation pattern RP1 exhibiting a single, large lobe substantially centered at the angular position of the radiating apertures.

As depicted in FIG. 2(b), an arrangement A2 wherein a plurality of radiating apertures is arranged in a first straight line 41 and in a second straight line 42 diametrically opposed one another provides a radiation pattern RP2 exhibiting two substantially diametrically opposed lobes. If the shape, size and reciprocal distance of the apertures in the first line 41 and second line 42 are substantially the same, the two lobes substantially have the same angular width and amplitude.

FIG. 2(c) depicts instead an arrangement A3 wherein the radiating apertures in the first line 41 are wider than the radiating apertures in the diametrically opposed second line 42. In this case, the resulting radiation pattern RP3 has two lobes having different angular widths and amplitudes, the lobe centered at the angular position of the first line 41 of wider apertures having a larger angular width and amplitude then the other one.

FIG. 2(d) depicts an arrangement A4 wherein the first line 41 of radiating apertures and the second line 42 of radiating apertures, having substantially the same dimension, are not diametrically opposed, but are instead located at angular positions spaced by an angle comprised between 90° and 180°. In this case, the resulting radiation pattern RP4 has two lobes which are not diametrically opposed, but are instead roughly centered at the angular positions of the respective lines 41, 42 of radiating apertures.

FIG. 2(e) depicts an arrangement A5 wherein the angle between the angular positions of the first line 41 of radiating apertures and second line 42 of radiating apertures is decreased until the radiating apertures of the two lines 41, 42 are substantially merged into a single line of very large radiating apertures. In this case, the resulting radiation pattern RP5 has a single lobe, whose amplitude and angular width are particularly high.

As depicted in FIG. 2(f), an arrangement A6 of radiating apertures distributed in four longitudinal lines 41, 42, 43, 44 located at angular positions reciprocally spaced by angles of 90° results in a radiation pattern RP6 exhibiting four lobes centered at the angular positions of the lines 41, 42, 43, 44, respectively. If the shape, size and reciprocal spacing of the radiating apertures is substantially the same in all four lines 41, 42, 43, 44, the four lobes substantially have the same angular width and amplitude. Otherwise, the lobes may have different angular widths and amplitudes, as discussed above with reference to FIG. 2(c).

As depicted in FIG. 2(g), where the conductive shield 4 comprises no radiating aperture, the radiation pattern RP7 is null, namely the cable 10 behaves as a normal (namely, non radiating) coaxial cable.

The arrangements of FIGS. 2(a)-(g) are merely exemplary. Other arrangements of the radiating apertures along a cable and between the cable ends may be provided, which result in radiation patterns with other shapes.

In the conductive shield 4 of the cable 10, for example, the variation of the geometric properties of the radiating apertures in the longitudinal direction of the cable 10 may be implemented as a transition from one of the arrangements A1-A6 shown in FIGS. 2(a)-2(f) (or any other possible known arrangement) to another one of such arrangements. Such transition results in a variation of the shape of the radiation pattern of the cable 10. For example, a transition from the arrangement A1 (single straight line of radiating apertures) to the arrangement A2 or A3 (two diametrically opposed straight lines of radiating apertures) results in a change of the number of lobes of the radiation pattern (from 1 to 2). As another example, a transition from the arrangement A2 (two diametrically opposed straight lines of radiating apertures with substantially the same shape and size) to the arrangement A3 (two diametrically opposed straight lines of radiating apertures with substantially the same shape but different sizes) A3 results in a change of the relative amplitudes of the two lobes of the radiation pattern.

Several transitions may be provided along a single cable 10, so that its conductive shield 4 is virtually divided into a number of contiguous sections (e.g. sections 4A, 4B, 4C in FIG. 1), each section being provided with a respective arrangement of radiating apertures and, hence, with a respective radiation pattern having a certain shape. One or more sections may have no radiating apertures, as depicted in FIG. 2(f).

The transition between the arrangements of two consecutive sections 4A-4B or 4B-4C may be either single-step or gradual.

For example, transition between the arrangement A1 (single straight line of radiating apertures) to the arrangement A2 (two diametrically opposed straight lines of radiating apertures) or vice versa may be single-step. As another example, transition from the arrangement A2 (two diametrically opposed straight lines of radiating apertures with the same shape and size) to the arrangement of A3 (two diametrically opposed straight lines of radiating apertures with the same shape but different sizes) may be implemented by gradually increasing the size of the radiating apertures in the first line 41 from their smaller size in the arrangement A2 to their larger size in the arrangement of A3.

If all the geometric properties of the radiating apertures are kept constant in the longitudinal direction of the cable 10, the radiated power slightly decreases along the cable 10, due to attenuation of the cable 10. Instead, by varying a geometric property of the radiating apertures (such as their size or their reciprocal distance) along the longitudinal direction of the cable 10, the radiation pattern still exhibits a single lobe, but its amplitude—namely, the radiated power—may be varied longitudinally in a purported way.

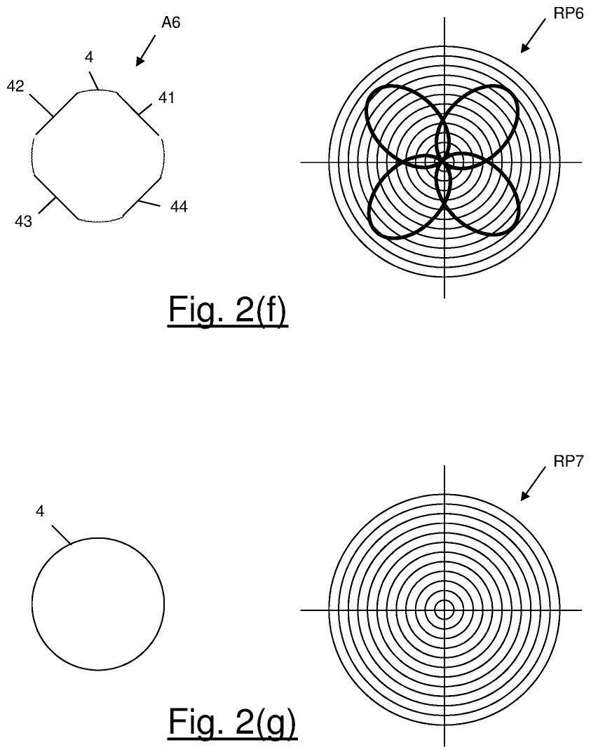

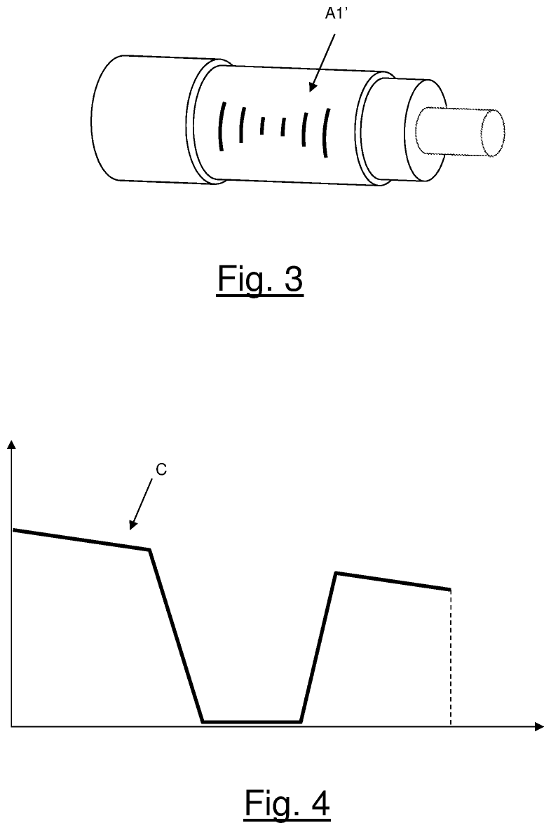

FIG. 3 shows a variant A1′ of the arrangement A1 of FIG. 2(a) (radiating apertures in a single straight line). As described above, the resulting radiation pattern has a single lobe whose amplitude is indicative of the power radiated by the cable 10.

In the arrangement A1′ shown in FIG. 3, for example, a geometric property (the size) of the radiating apertures in the conductive shield 4 is varied in a non-monotonic way longitudinally along the cable 10. For example the aperture size is firstly decreased to a minimum value, then kept constant and then increased again to the original value.

The resulting variation of the radiation pattern, in particular of the radiated power, in the longitudinal direction of the cable 10 is depicted in FIG. 4 by the curve C. The graph of FIG. 4 plots the radiated power (in ordinate) versus the longitudinal position of the cable of FIG. 3 (in abscissa). Curve C is non-monotonic, namely it firstly exhibits a slight decrease due to attenuation in the cable 10, followed by a steeper decrease due to the cumulative effect of both attenuation and increasing coupling loss of the cable 10, the latter being due to the decreasing size of the radiating apertures according to the arrangement A1′. Then, the radiated power is almost constantly equal to a minimum value for a length of the cable 10, which corresponds to an installation area where a low-radiofrequency coverage is required. Then, the radiated power exhibits a steep increase due to the decreasing coupling loss of the cable 10 corresponding to the size increasing of the radiating apertures according to the arrangement A1′. The radiated power finally exhibits again a slightly decreasing profile due to attenuation of the cable 10.

Similar non-monotonic variations of a geometric property of the radiating apertures may be applied also to other arrangements of radiating apertures, for example any of the arrangements A2-A6 shown in FIGS. 2(b)-(f).

Hence, by suitably varying at least one of the geometrical properties of the radiating apertures in the longitudinal direction of the cable 10, the shape of the radiation pattern of the cable 10 may be longitudinally varied from end to end according to the radiofrequency coverage needs. This way, the cable 10 may be used to provide a non-uniform radiofrequency coverage, e.g. in contexts (e.g. a building) wherein different areas have different coverage requirements are present.

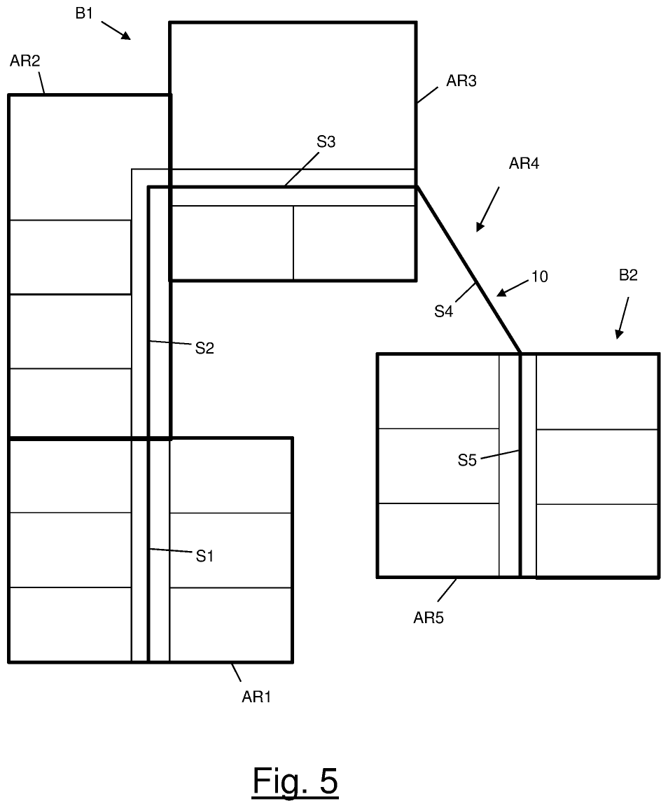

FIG. 5 shows an exemplary scenario, wherein two buildings (e.g. of a same company) need to be provided with radiofrequency coverage.

The first building B1 is a single floor building and has a first area AR1 with rooms arranged on both sides of a corridor, a second area AR2 with rooms arranged on a single side of the corridor and a third area AR3 with rooms on one side of the corridor and a larger room (e.g. a canteen) of the other side of the corridor. A fourth area AR4 corresponds to a cable passage between the two buildings. The second building B2 is instead a double floor building with a single area AR5 with rooms arranged on both sides of the corridor.

In order to provide a radiofrequency coverage to buildings B1 and B2, a single radiating coaxial cable according to the present disclosure may be used, whose conductive shield has a section with radiating aperture arrangement designed for each area. In particular, the conductive shield of the cable may have a first section S1 for the area AR1, whose radiating apertures are arranged according to the arrangement A2 shown in FIG. 2(b).

The first section S1 may be followed by a second section S2 for installation in area AR2, whose radiating apertures are arranged according to the arrangement A1 shown in FIG. 2(a). A non monotonic variation of the radiating apertures size may be provided if a particular longitudinal variation of the radiated power is desired across the area AR2.

The second section S2 may be followed by a third section S3 for installation in the area AR3, whose radiating apertures are arranged according to the arrangement A3 shown in FIG. 2(c) with, for example, the straight line 41 oriented towards the larger room of this area. Alternatively, the arrangement A5 shown in FIG. 2(e) can be provided.

The third section S3 may be followed by a fourth section S4 with no radiating apertures, for installation in the cable passage of area AR4.

The fourth section S4 may be then followed by a fifth section S5 for installation in the area AR5, whose radiating apertures are arranged according to the arrangement A6 shown in FIG. 2(f) to provide radiofrequency coverage to both the floors of the building B2.

Use of a single cable 10 to provide radiofrequency coverage to the various areas of the buildings B1, B2 makes the installation procedure quicker and simpler, thereby allowing saving installation costs. Moreover, since no joints between different lengths of cable are required, the loss of the overall line is decreased.

What is claimed is:

1. A radiating coaxial cable comprising:
an inner conductor;
an insulating layer surrounding and directly contacting the inner conductor;
a continuous conductive shield surrounding said insulating layer and comprising a plurality of radiating apertures; and
a jacket surrounding the conductive shield, wherein at least one geometric property of the plurality of radiating apertures varies along a longitudinal direction of the cable and the cable has a radiation pattern with a shape longitudinally varying in a predefined way.

2. The radiating coaxial cable according to claim 1, wherein the conductive shield is in the form of a smooth or corrugated metal layer.

3. The radiating coaxial cable according to claim 2, wherein the conductive shield is in the form of a smooth metal layer.

4. The radiating coaxial cable according to claim 1, wherein the at least one geometric property comprises a geometric property of a single radiating aperture.

5. The radiating coaxial cable according to claim 4, wherein the geometric property of the single radiating aperture includes shape, size, orientation or angular position of the single radiating aperture.

6. The radiating coaxial cable according to claim 1, wherein the at least one geometric property comprises a geometric property collectively describing an arrangement in a set of radiating apertures on the conductive shield.

7. The radiating coaxial cable according to claim 6, wherein the geometric property collectively describing the arrangement includes reciprocal radial and/or longitudinal position, number of lines according to which the radiating apertures are arranged and shape of the lines.

8. The radiating coaxial cable according to claim 1, further comprising at least two contiguous sections having different arrangements of the radiating apertures and radiation patterns with different shapes.

9. The radiating coaxial cable according to claim 8, wherein the arrangement of the radiating apertures in each one of the at least two contiguous sections comprises a single alignment, a double alignment, or a multiple alignment of radiating apertures.

10. The radiating coaxial cable according to claim 8, wherein a transition between the arrangements of the radiating apertures in the two contiguous sections is single-step or gradual.

11. The radiating coaxial cable according to claim 8, further comprising at least one section, wherein the at least one geometric property of the radiating apertures is varied in a non-monotonic way.

12. The radiating coaxial cable according to claim 8, further comprising at least one section with no radiating apertures.

13. A process for manufacturing a radiating coaxial cable, the process comprising:
surrounding an inner conductor with an insulating layer, the insulating layer directly contacting the inner conductor;
providing a continuous conductive shield in the form of an electrically conductive metal foil comprising, from end to end, a plurality of radiating apertures, the metal foil longitudinally wrapping the insulating layer; and
surrounding the conductive shield with a jacket, at least one geometric property of the plurality of radiating apertures varying along a longitudinal direction of the cable and the cable having a radiation pattern with a shape longitudinally varying in a predefined way.

14. The process according to claim 13, wherein the at least one geometric property comprises a geometric property of a single radiating aperture.

15. The process according to claim 13, wherein the at least one geometric property comprises a geometric property collectively describing an arrangement in a set of radiating apertures on the conductive shield.

16. A method for providing a varying radiofrequency coverage, the method comprising:
transmitting a radiofrequency signal by using a single radiating coaxial cable comprising an inner conductor, an insulating layer, a continuous conductive shield, and a jacket, the insulating layer surrounding and directly contacting the inner conductor, the continuous conductive shield surrounding the insulating layer and comprising a plurality of radiating apertures, and the jacket surrounding the conductive shield, wherein at least one geometric property of the plurality of radiating apertures varies along a longitudinal direction of the cable and the cable has, from end to end, a radiation pattern with a shape longitudinally varying in a predefined way.

17. The method according to claim 16, wherein the radiofrequency signal transmitted by the cable has a frequency varying from 20 Hz to 10 GHz.

18. The method according to claim 17, wherein the frequency of the radiofrequency signal varies from 5 MHz to 4 GHz.

19. The method according to claim 16, wherein the at least one geometric property comprises a geometric property of a single radiating aperture.

20. The method according to claim 16, wherein the at least one geometric property comprises a geometric property collectively describing an arrangement in a set of radiating apertures on the conductive shield.
